(19) United States
(12) Patent Application Publication
(10) Pub. No.: US 2012/0013126 A1
(43) Pub. Date: Jan. 19, 2012

(54) WATER ELEVATION TYPE WAVE ENERGY CONVERTER AND METHOD OF CONVERSION OF WAVE ENERGY

(76) Inventor: Padraig Molloy, Craughwell (IE)

(21) Appl. No.: 12/997,731

(22) PCT Filed: Jun. 10, 2009
(86) PCT No.: PCT/EP2009/004182

§ 371 Date: May 31, 2011

Related U.S. Application Data
(60) Provisional application No. 61/060,509, filed on Jun. 11, 2008.

(30) Foreign Application Priority Data
Jun. 11, 2008 (EP) 08010590.1

(51) Int. Cl. F03B 13/22; F03B 17/06

(52) U.S. Cl. 290/53; 60/640

(57) ABSTRACT

The present invention relates to an energy system and method suitable for converting wave energy of a body of water into movement of a drive train to capture energy comprising a vessel sitting on said body of water having a hull (1) adapted to roll freely in response to said wave energy; and a plurality of inclined channels (4) mounted within and/or on the hull (1) that are positioned to convert the rolling motion of the hull to vertical displacement of water, such that said vertical displacement of water can then be allowed flow under gravity through a conversion capture system (9) to capture energy. The invention provides a valve-less water elevation energy system. The invention also provides a mooring system (15) suitable for connecting the vessel with an anchor, the mooring system adapted to facilitate unhindered rolling motion of the vessel and maximise energy capture.

### FIELD OF THE INVENTION

The invention relates to a system suitable for converting wave energy, and optionally in combination with wind energy, into the vertical displacement of water.

In particular, the invention relates to a power generation vessel suitable for converting wave energy, and optionally in combination with wind energy, into a continuous flow of water suitable to actuate a water flow energy capture system and thereby a drive train to generate/capture energy.

### BACKGROUND TO THE INVENTION

Inclined channel devices to elevate water in rolling vessels are known to convert the potential energy of the elevated water into power. Typically such inclined channel devices require valves as an integral part of these designs. The presence of such valves is a very significant design weakness and leads to the problem that the valves need to be maintained which is difficult in a harsh environment.

UK Patent Number GB05788, McFarland, discloses a vessel that provides an inclined channel to elevate water as a vessel rolls, and then using the elevated water to drive a turbine as it descends. A problem with McFarlands design is that each embodiment requires a series of valves. McFarland's design elevates water in six stages in each embodiment shown that requires a number of valves. Each embodiment shown in McFarland describes a cross trough or turn channel, as shown in the Figures, such that the cross trough as linking one upwardly rising channel with the next and whose axis is aligned with the rolling axis of the vessel. The cross troughs act somewhat like a hairpin bend on a road ascending a mountain. These cross troughs must use a valve to retain the liquid they contain as otherwise it will descend on the return roll of the vessel. For example, if a vessel rolls in use with a period of 5 seconds that means that each valve in McFarland's design will be operated 17,000 times per day or approximately 6,000,000 times per annum. In addition, at the bottom of these cross troughs in FIGS. 2, 3 and 4 as shown at the same level as the channels entering and leaving the channels. Without valves these cross-troughs do not impound any water of themselves. In McFarland's application the ducts are shown as straight inclined elements and no reference is made to any optimisation of duct shape to maximise water elevation. The hull shape in McFarland's design is not optimised for maximum roll. The hull shapes shown are not designed to minimise rolling resistance of the vessel and no mention is made in the application of considering such hull shapes. In addition McFarland does not use a wind energy capture device in order to amplify the rolling motion of the vessel.

French patent publication number FR 2 455 193 A, Rodriguez, discloses a similar system to the system described in the McFarland patent, in that a series of interconnecting inclined ducts are used to elevate water from the body of water in which the vessel is floating, as the vessel rolls under wave action. A multihull vessel is shown anchored beam on to the waves. Multihull vessels are significantly more stable than monohull and thus the motion that the vessel seeks to utilise will not be optimal. Again the main problem with operating this system is the use of valves. Each inclined channel has a valved entry gate to the next upwardly inclined duct. In order elevate the water to the top it takes eleven stages to reach a header tank such that a total of eleven valves are required. Each valve represents a moving part and a design weakness. For example, as with McFarland, if a vessel rolls with a period of 5 seconds that means that each valve in Rodriguez's design will be operated 17,000 times per day or approximately 6,000,000 times per annum. No channel shape optimization is considered and no use of a wind capture device is considered.

PCT Patent Publication Number WO00/08334, Ottersen, discloses a three-dimensional two-phase wind-wave converter for generating energy by harvesting wind and wave energy that requires complex hydraulics.

There is therefore a need to provide a power generation vessel and method suitable for converting wave energy into a continuous flow of water suitable to actuate a water flow capture system to generate power that overcomes the above mentioned problems.

### SUMMARY OF THE INVENTION

According to the invention there is provided, as set out in the appended claims, an energy system suitable for converting wave energy of a body of water into movement of a drive train to capture energy comprising:
a vessel, sitting on said body of water, having a hull adapted to roll freely in response to said wave energy;
a plurality of inclined valve-less channels mounted within and/or on the hull that are positioned to convert the rolling motion of the hull to vertical displacement of water, such that said vertical displacement of water can then be allowed flow under gravity through an energy conversion system to capture energy; and
a plurality of reservoirs, wherein a separate reservoir for receiving water is positioned at one or more ends of the plurality of inclined channels, such that water can only travel from a reservoir up the next inclined channel to a next reservoir in response to the rolling action of the hull to provide vertical displacement of water.

The hull and channel system is designed such that water enters through ducts located in the hull that are either continuously or intermittently immersed in water as the vessel rolls on a body of water, for example sea/lake/river/ocean etc. As the vessels rolls the water flows from reservoir to reservoir, entering each reservoir at the top and exiting at the bottom. The reservoir design ensures that no valves are required for operation, in other words the invention provides a valve-less design. At least one or each of the reservoirs comprise one entry port for water such that the entry port is positioned above a level of an exit port, leading to valve-less water entrapment. When the vessel rolls in the opposite direction the water in to reservoir can only escape by the exit port and up the inclined channel to the next reservoir, thus elevating the water. The outflow from the last or topmost reservoir flows into a header tank from which it may be discharged under the gravity through a flow capture and energy conversion system. There are a number of very significant differences which represent a notable inventive step and make usage of a device with an inclined channel feasible.

It will be appreciated that the invention does not require the use any valves whatsoever, i.e. a valve-less design. The inventive nature of the entrapment of the liquid/water by a series of reservoirs means that no valves are necessary. Liquid/water is entrapped at each level for each rolling action. Water flows up a conduit/channel as the vessel rolls and enters the top of the reservoir for that stage. The main body of water in the reservoir cannot flow back due to the dimension of the reservoir down as the outflow conduit for that reservoir, exits the bottom of the reservoir, and leads upwards to the reservoir on the next level.

In one embodiment, as the vessels rolls, water flows from reservoir to reservoir connected by at least one of said plurality of channels, said water entering each reservoir at the top and exiting at the bottom.

In one embodiment the reservoirs are positioned at a plurality of different levels in said vessel.

In one embodiment the main body of water cannot flow back down a channel due to the dimension of the reservoir as the outflow conduit for that reservoir, exits the bottom of the reservoir to a next inclined channel, and leads upwards to another reservoir on the next level.

In one embodiment at least one reservoir comprises a curved shape to modify dynamic peak loads and sloshing effects due to water displacement to optimise roll characteristics of the vessel.

In one embodiment there is provided at least one channel comprises at least one intermediate reservoir positioned between both ends of said channel. Suitably, the channel is provided with a intermediate reservoir on the inclined channel. In a further embodiment at least one channel can be provided with a plurality of intermediate channels on the channel surface.

Ideally the invention provides a mooring system suitable for connecting the vessel with an anchor, the mooring system adapted to facilitate unhindered the rolling motion of the vessel in the water. In other words the mooring system is adapted to minimise energy dissipation due to the rolling motion of the vessel.

In a preferred embodiment of the invention, the system comprises an anchor which is suitably fixed with respect to the vessel but allowing the vessel to roll freely. Typically, the anchor comprises a riser fixed to the sea bed and optionally fixed to the mooring system through a swivel adapted to swivel in response to the orientation of the vessel relative to the anchor. Ideally, the mooring system tethers the vessel to the anchor about two pivot or clevis type attachments located on each end of the hull at or close to the vessels longitudinal axis of rotation. In one embodiment, the mooring system is adapted to bias the hull of the vessel into an orientation where it is beam-on to the direction of the wind and/or wave and/or optimal orientation, depending on the conditions.

Ideally a closed loop system is provided such that the water allowed flow under gravity through the energy capture system is delivered back to lower channels of said plurality of channels for subsequent vertical displacement. The closed loop system is possible as fluid discharged from the flow capture system is fed back into the lower reservoirs and not released back into the sea/lake/river where the vessel is floating. The advantage of the closed loop system is that no debris/dirt/silt/seaweed/plastic, that can be present in sea water, to impede operation of the system.

In another embodiment of the present invention the vessel comprises a wind capture system capable of controllably presenting a variable wind heeling load to amplify the hulls rolling motion. In this manner, the hull rolling motion is amplified to maximise the vessel rolling motion. Suitably, the wind capture system is adapted to amplify the hulls rolling motion by increasing the wind heeling load on the hull at a forward point of roll and decreasing the wind heeling load on the hull at an aft point of roll. The term “forward point of roll” should be understood to mean that position when the vessel is heeling to windward. The term “aft point of roll” should be understood to mean that position when the vessel is heeling to leeward.

Generally, the variation of the wind loading on the hull is synchronised with the rolling of the hull. Various means of providing such synchronisation can be employed, according to the present invention. Thus, in one embodiment, the wind capture system is operatively connected to the mooring system or the drive train such that the variation in captured wind heeling load on the hull is synchronised with the rolling of the hull. In one embodiment, the wind capture system comprises a system of shutters in which wind heeling load on the hull is varied by opening and closing the shutters. Typically, the system of shutters is mounted on a mast. Ideally, the vessel comprises a plurality of shutters, each suitably mounted on a separate mast. As such, when a system of shutters mounted on a mast is employed, the mast (including the shutter system) may be rotatable with respect to the vessel, or the system of shutters may be rotatable on the mast. Either way, the system of shutters may be rotated into a favourable orientation with respect to the wind direction and/or rotated in phase with the rolling motion of the waves.

Ideally, a section of a part of the hull intended to be underwater is semi-circular. However, other designs of hull which optimises the performance of the rolling motion of the hull/vessel. Suitably, the profile of the hull may be half-cylindrical.

In another embodiment, the invention relates to a system for converting wind and wave energy into vertical elevation of water and hence into electricity as the waters potential energy is recovered. The flow is converted to a mechanical output by conventional means and hence used to drive an electricity generator operatively connected to the drive train. Typically, the system includes electrical power transmission means for transmitting electrical power from the vessel.

The invention also relates to a vessel suitable for forming part of the power generation system of the invention and comprising a vessel having a hull shaped to roll freely in response to the action of the wind and waves, and a wind capture system capable of controllably presenting a variable wind heeling load to amplify the hulls rolling motion.

Ideally, the wind capture system comprises wind heeling load variation means to amplify the hulls rolling motion by increasing wind heeling load on the hull at a forward point of roll and decreasing wind heeling load on the hull at an leeward point of roll. Typically, the wind capture system is operatively connected to the mooring system or the drive train such that the changes in wind heeling load on the hull are synchronised with the rolling of the hull.

In one embodiment, the wind capture system comprises a system of shutters in which wind heeling load on the hull is varied by opening and closing the shutters. Suitably, system of shutters is mounted on a mast, wherein the vessel ideally comprises a plurality of shutter systems, each mounted on a mast.

In another embodiment, the wind capture system can rotate with respect to the vessel and optionally in phase with the rolling motion of the water to accentuate rolling displacement of the water. Suitably the wind capture system can be adapted to provide a dampening mechanism depending on the rolling motion of the vessel.

The invention also relates to a method of generating electricity comprising a step of positioning an electricity generation system according to the invention in a body of water exposed to wind and wave motion, and converting the wind and wave energy into electricity.

In a further embodiment there is provided an energy system suitable for converting wave energy of a body of water into movement of a drive train to capture energy comprising: a vessel, sitting on said body of water, having a hull adapted to roll freely in response to said wave energy; and at least one or more inclined channels mounted within and/or on the hull that are positioned to convert the rolling motion of the hull to vertical displacement of water, such that said vertical displacement of water can then be allowed flow under gravity through an energy conversion system to capture energy.

In another embodiment there is provided a method for converting wave energy of a body of water into movement of a drive train to generate energy comprising:
adapting a vessel, sitting on said body of water, having a hull to roll freely in response to said wave energy; and
positioning at least one or more inclined channels mounted within and/or on the hull to convert the rolling motion of the hull to vertical displacement of water, such that said vertical displacement of water can then be allowed flow under gravity through an energy conversion system to capture energy.

In a further embodiment there is provided a valve-less water elevation energy system suitable for converting wave energy of a body of water into movement of a drive train to capture energy comprising:
a vessel, sitting on said body of water, having a hull adapted to roll freely in response to said wave energy;
a plurality of inclined channels mounted within and/or on the hull that are positioned to convert the rolling motion of the hull to vertical displacement of water, such that said vertical displacement of water can then be allowed flow under gravity through an energy conversion system to capture energy; and
a plurality of reservoirs, wherein a separate reservoir for receiving water is positioned at one or more ends of the plurality of inclined channels, such that water can only travel from said plurality of reservoirs up the next inclined channel in response to the rolling action of the hull.

### BRIEF DESCRIPTION OF THE DRAWINGS

The invention will be more clearly understood from the following description of some embodiment thereof, given by way of example only, with reference to the accompanying figures in which:

FIG. 1 illustrates an isometric projection of a wave energy conversion system according to the present invention;

FIG. 2 illustrates a projection of a wave energy conversion vessel of the present invention;

FIG. 3 illustrates an isometric projection of a wave energy conversion vessel according to the present invention;

FIGS. 4a to 4e illustrates a projection of a wave energy conversion vessel with an enlarged section of a reservoir according to the present invention;

FIGS. 5a to 5e illustrates a number of views of an inclined channel system according to the present invention;

FIG. 6 illustrates a projection of a wave energy conversion vessel according to another aspect of the present invention;

FIGS. 7a & 7b illustrates a projection of a wave energy conversion vessel according to further aspects of the present invention;

FIG. 8 illustrates a projection of a wind and wave energy conversion vessel of another embodiment of the present invention;

FIG. 9 illustrates an isometric projection of a wave and wind energy conversion vessel of FIG. 8; and

FIG. 10 illustrates an isometric projection of a wave and wind energy conversion vessel of FIG. 8.

### DETAILED DESCRIPTION OF THE DRAWINGS

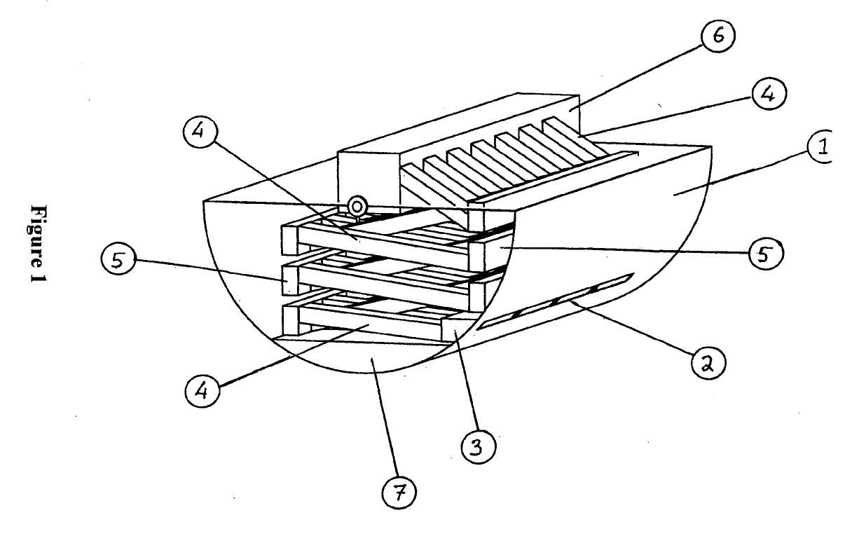

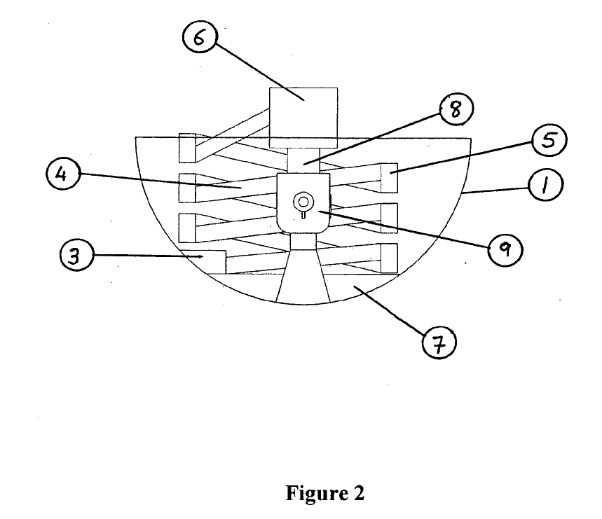

A system for the conversion of wave (and optionally wind energy) to electrical power is illustrated in attached FIGS. 1 to 10 according to the invention.

As shown in FIGS. 1, 2 and 3 there is provided a hull (1) within which is mounted a water entry grill (2) which allows water enter the base reservoir(s) (3) in the hull. From this reservoir the water is channelled upward through a system of ducts or channels (4) and/or reservoirs (5) up to the topmost reservoir or header tank (6). The channel or channels can be of any shape or suitable dimension to enable vertical displacement of water.

As the vessel rolls to the action of waves (and/or wind) water flows through the inclined channel up to the next reservoir in the series. In each case water enters each reservoir through the top and exits at the bottom. In this way the design of the reservoirs ensures that water only is only channelled in an upward direction. It will be appreciated that an important aspect of the invention ensures that the system requires no valves or moving mechanical parts due to dimension and action of the reservoirs. At least one or each of the reservoirs comprise an entry port and an exit port, such that such that the entry port is positioned above a level of the exit port, to provide for valve-less water entrapment in each reservoir when said vessel rolls in one direction.

Water flows from the topmost reservoir through a duct/channel (8) and hence through a turbine (9) and then through an exit duct/channel (14). In a separate embodiment the turbine outlet channel or duct or exit channel or duct can be connected to base reservoir (3) and hence operate as a closed loop system.

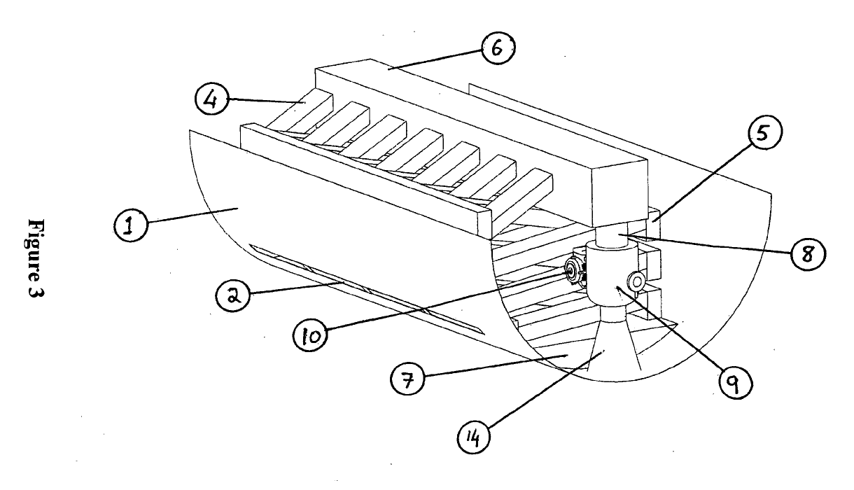

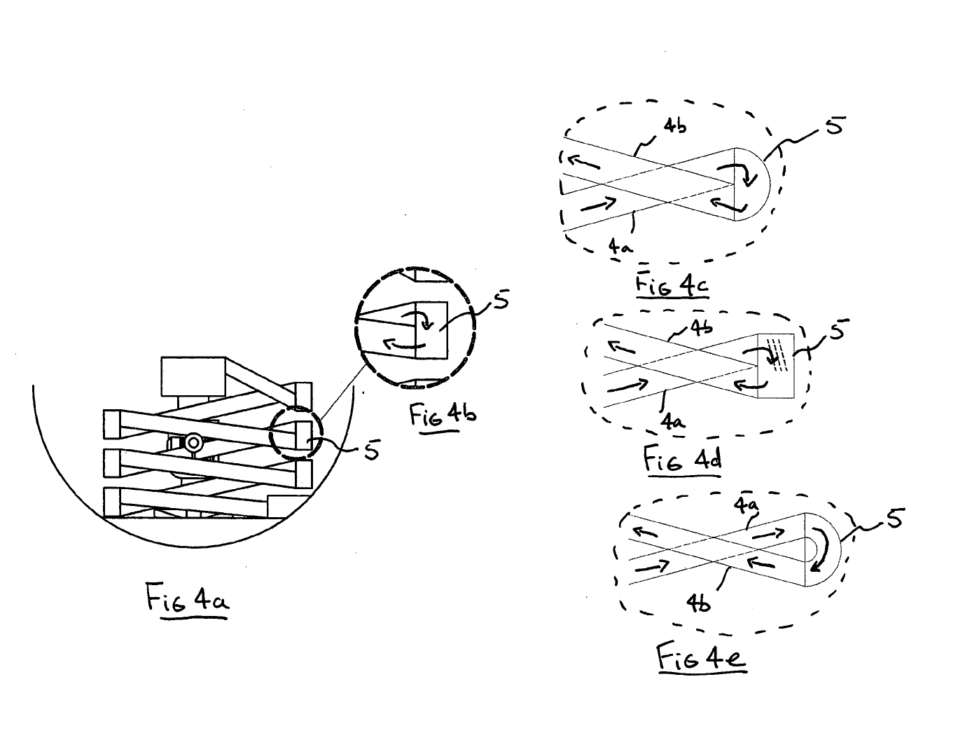

Referring now to FIGS. 4a to 4e, which is similar to FIG. 3 except with enlarged views of the reservoir (5) to illustrate operation of the invention. As the vessels rolls, water flows from reservoir to reservoir connected by at least one of the channels. Water enters each reservoir at the top entry port and exits at the bottom exit port. The main body of water in the reservoir cannot flow back down the channel due to the dimension of the reservoir as the outflow conduit (or exit port) for that reservoir, exits the bottom of the reservoir to a next inclined channel, and leads upwards to another reservoir on the next level and enters the next reservoir entry port. It will be appreciated that the shape of the reservoir can be adapted to modify reservoir shape in order to convert water kinetic energy to potential energy and also minimise dynamic peak loads due to water deceleration achieve a similar objective. FIGS. 4b to 4e illustrate the flow of water for different shaped reservoirs (5) to achieve optimum performance. Each entry port is positioned above a level of the exit port, to provide for valve-less water entrapment in each reservoir when said vessel rolls in one direction. As the vessel shown in FIG. 4a rolls to the right water flows from the channel (4a) in the entry port and into the reservoir (5). As the vessel rolls to the left, the water in the reservoir (5) exits the exit port and into the next channel (4b). The flow of water is shown by the arrows in FIGS. 4b to 4e.

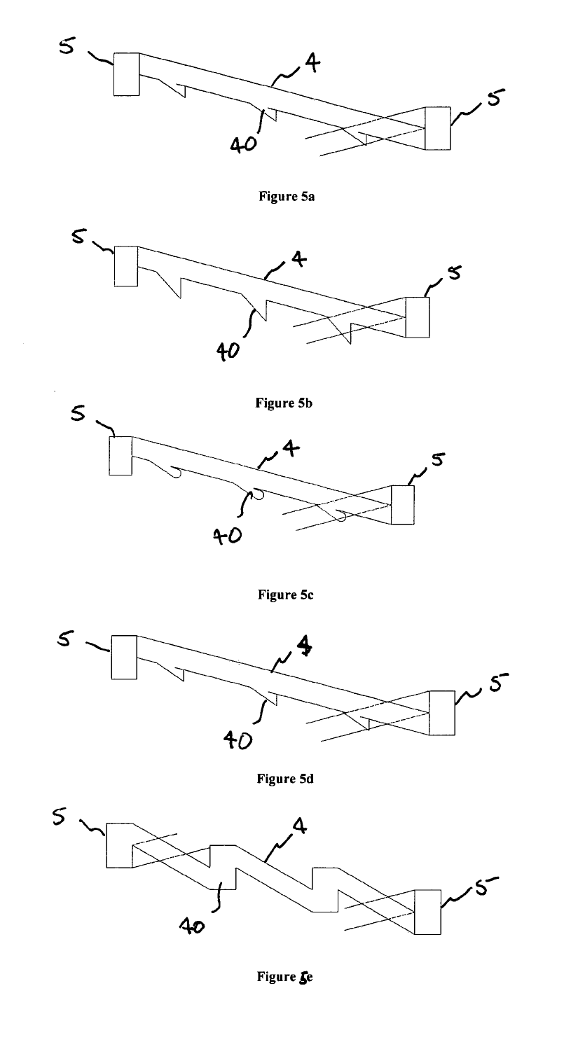

FIGS. 5a to 5e illustrates a further embodiment of the channels (4) according to another aspect of the invention at least one channel comprises at least one intermediate (40) reservoir positioned between both ends of said channel. As shown in FIGS. 5a to 5e a number of intermediate reservoirs can be provided along the base of the channel (4). The intermediate reservoirs ensures that no water that is vertically displaced runs back down the channel (4) on the next vessel roll.

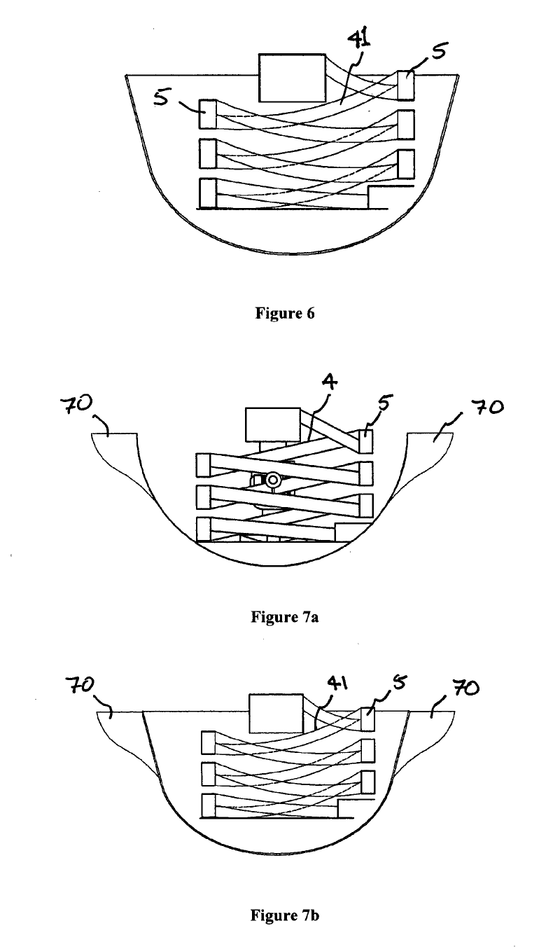

Referring now to FIG. 6 illustrates a further embodiment of the invention. The channels comprise a curved duct shape (41) that is optimised to convert water kinetic energy to potential energy and also minimise dynamic peak loads due to water deceleration. Conversion of the relative but out-of-phase relative velocities of the vessel and the water it contains to an increase in elevation or potential energy of this water will be functionally but not optimally addressed by designs utilising straight inclined ducts. Duct shape will be influenced by water and vessel motion characteristics. It will be appreciated that harmonic, parabolic, cycloidal and polynomial motion characteristics, amongst others, may be used create duct profiles designed to maximise water vertical displacement and thereby vessel energy capture efficiency.

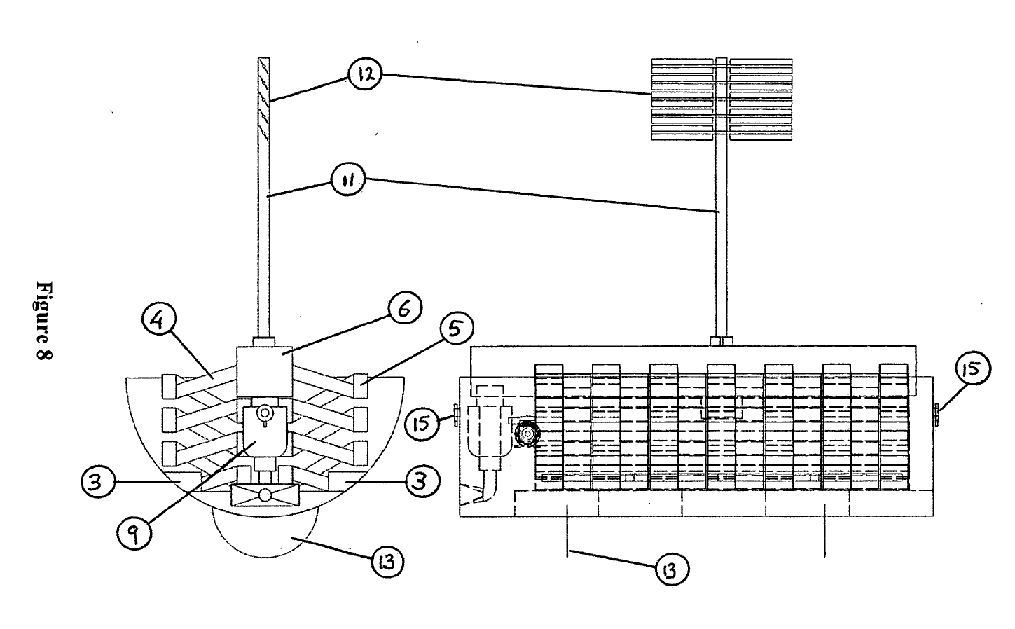

Referring now to FIGS. 7a and 7b illustrates a further embodiment of the hull design according to another aspect of the invention. The hull (70) is adapted to optimise rolling performance of the vessel and prevent capsizing. Instead the hull (70) can be flared (or chined) to optimally position the center of buoyancy as the vessel rolls and thereby positively alter the righting moment, improving the energy capture functionality of the vessel and minimise the possibility of an inversion or capsize. It will be appreciated that a number of stabilising chines can be provided to change the centre of buoyancy of the vessel to prevent the vessel from capsizing.

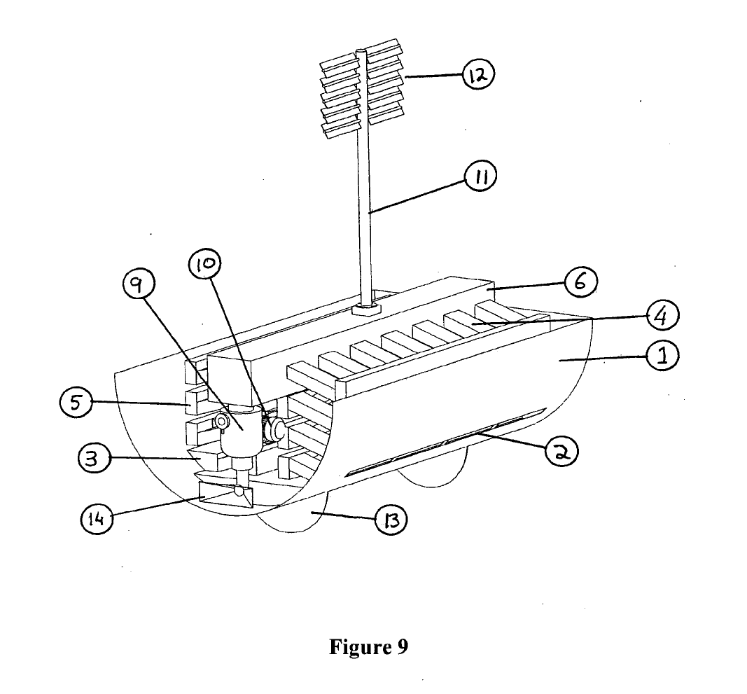

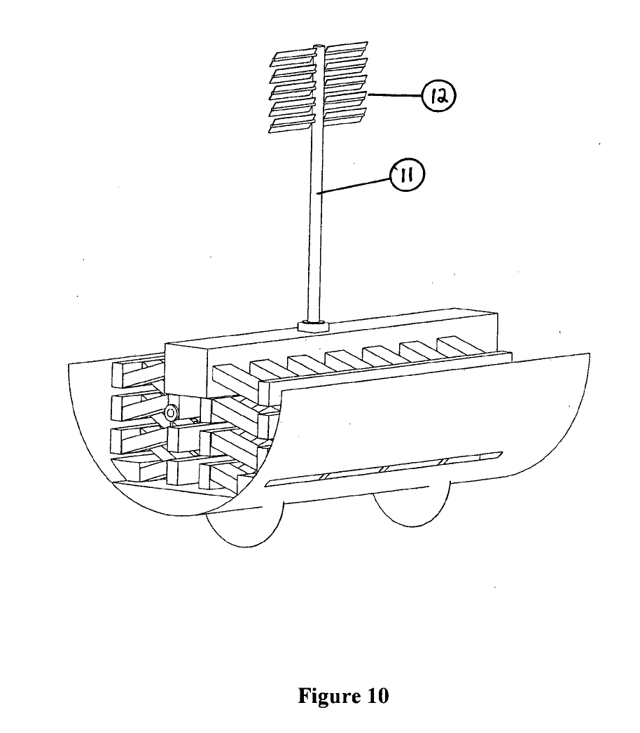

In the embodiment shown in FIGS. 8, 9 and 10 on the hull is mounted one or more masts or structures (11) on which in turn is mounted a wind capture element (12) or sail capable of rotating about the vertical axis on the mast, or is mounted on the mast a wind capture device consisting of multiple slats (mounted either horizontally or vertically) capable of being opened or closed (12) (as shown in FIG. 8, FIG. 9 and FIG. 10).

The hull is designed to lie abeam of the seas and at right angles to the prevailing wind. The invention is designed such that internal (7) and external masses (13) act as counterweights to the rigs heeling influence and provide a righting moment to the vessel. The wind capture system is used to maximise the hulls rolling motion by maximising wind heeling load at the forward or windward point of roll of the vessel (into the wind/waves) and maintaining that wind loading as the vessel rolls away from the wind. The wind capture system minimises wind heeling load at the leeward or aft point of roll (vessel is rolled away from the wind) and maintains that minimised wind loading as the vessel rolls to windward. By operating the wind capture system in phase with rolling motion caused by wave action on the hull of the vessel, the vessel's angle of roll is thereby amplified. The energy released by the wind and waves causing the rolling motion of the vessel are captured by water elevator system shown. The attachment points for the vessels mooring system (15) sit on or close to the vessels axis of rotation and the anchor system is secured to the vessel at these clevis type attachment points thereby leaving the vessel roll unrestricted.

In a separate embodiment the vessels vertical motion, rise and fall or heave, are captured by the vessel's mooring system and an associated onboard drive train. This is particularly suitable for conditions where there is a large rolling motion or high amplitude in the rolling motion to further capture energy as the vessel rises and falls.

It will be appreciated that the invention can provide a single flow system as in FIGS. 1, 2 and 3 or multiple systems as in FIGS. 8, 9 and 10. The vessel may use an internal ballast (7) and/or external ballast (13) to balance the vessel and providing a righting moment.

It will be appreciated that in the context of the present invention that the terms channel and duct should be afforded the widest possible interpretation, so long as the channel or duct conveys the water to facilitate vertical displacement of water. Moreover it is envisaged that the invention will operate with any type of fluid and the term water used in the description and claims should be interpreted broadly as to mean any body of fluid.

It will be further appreciated that the channels or ducts are inclined at any suitable angle depending on the size of the vessel and length of the channels to allow for the vertical displacement of water. The reservoirs associated with each channel can be dimensioned to maximise the upward displacement of water relative to the body of water that the vessel is sitting on. Typically the channel or duct of the present invention can be of any shape or dimension, for example a slide inclined relative to surface of the body of water, when flat, and provided with a suitable geometry to enable vertical displacement of water.

While the invention has been described herein with reference to several especially preferred embodiments, these embodiments have been presented by way of example only, and not to limit the scope of the invention. Additional embodiments thereof will be obvious to those skilled in the art having the benefit of this detailed description, especially to meet specific requirements or conditions. Further modifications are also possible in alternative embodiments without departing from the inventive concept.

The invention is not limited to the embodiments hereinbefore described but may be varied in both construction and detail.

| Item | No. |
|---|---|
| Hull | 1 |
| Water entry grill | 2 |
| Entry or base reservoir | 3 |
| Water flow channels/ducts | 4, 4a, 4b |
| Reservoirs | 5 |
| Final reservoir/header tank | 6 |
| Internal ballast/counterweight | 7 |
| Turbine duct/channel | 8 |
| Turbine | 9 |
| Generator | 10 |
| Mast | 11 |
| Horizontal Axis Rotational Wind Capture Element | 12 |
| External counterweight/keel | 13 |
| Turbine Exit duct/channel | 14 |
| Mooring attachment structures | 15 |
| Intermediate Reservoirs | 40 |
| Curved Channel | 41 |
| Hull | 70 |

1. A system suitable for elevating a body of water, the system comprising:
a vessel, sitting on said body of water, having a hull adapted to roll freely in response to wave energy;
a plurality of inclined valve-less channels mounted within and/or on the hull that are positioned to convert the rolling motion of the hull to vertical displacement of water; and
a plurality of reservoirs, wherein a separate reservoir for receiving water is positioned at one or more ends of the plurality of inclined channels, such that water can only travel from a reservoir up the next inclined channel to a next reservoir in response to the rolling action of the hull to provide vertical displacement of water.

2. The system as claimed in claim 1 wherein, as the vessels rolls, water flows from reservoir to reservoir connected by at least one of said plurality of channels, said water entering each reservoir at the top and exiting at the bottom.

3. The system as claimed in claim 1 wherein at least one or each of the reservoirs comprise an entry port and an exit port, such that such that the entry port is positioned above a level of the exit port, to provide for valve-less water entrapment in said reservoir when said vessel rolls in one direction.

4. The system as claimed in claim 1 wherein the reservoirs are positioned at a plurality of different levels in said vessel.

5. The system as claimed in claim 1 wherein water cannot flow back down a channel due to the dimension of the reservoir as the outflow conduit for that reservoir, exits the bottom of the reservoir to a next inclined channel, and leads upwards to another reservoir on the next level.

6. The system as claimed in claim 1 wherein at least one channel comprises at least one intermediate reservoir positioned between both ends of said channel.

7. The system as claimed claim 1 wherein at least one reservoir comprises a curved shape to maximize conversion of water kinetic energy to potential energy and minimize dynamic peak loads due to water deceleration.

8. The system as claimed in claim 1 wherein at least one channel comprises a curved shape to maximize conversion of water kinetic energy to potential energy and minimize dynamic peak loads due to water deceleration.

9. The system as claimed in claim 1 comprising a mooring system suitable for connecting the vessel with an anchor, the mooring system adapted to minimize energy dissipation due to the rolling motion of the vessel in the water.

10-12. (canceled)

13. The system as claimed in claim 1 wherein a closed loop system is provided such that the water allowed flow under gravity through an energy capture system is delivered back to lower channels of said plurality of channels for subsequent vertical displacement.

14. The system as claimed in claim 1 wherein the vessel comprises a wind capture system capable of controllably presenting a variable wind heeling load to amplify the rolling motion of the hull.

15. The system as claimed in claim 1 wherein the vessel comprises a wind capture system capable of controllably presenting a variable wind heeling load to amplify the rolling motion of the hull, such that the wind capture system is adapted to amplify the hulls rolling motion by increasing the wind heeling load on the hull at a forward point of roll and decreasing the wind heeling load on the hull at an aft point of roll.

16. The system as claimed in claim 1 wherein the vessel comprises a wind capture system capable of controllably presenting a variable wind heeling load to amplify the rolling motion of the hull; and said wind capture system comprises means to vary the wind loading on the vessel to synchronize with the rolling motion of the vessel.

17. The system as claimed in claim 1 wherein the vessel comprises a wind capture system capable of controllably presenting a variable wind heeling load to amplify the rolling motion of the hull; and the wind capture system is operatively connected to the mooring system or the drive train such that the variation in captured wind heeling load on the hull is synchronized with the rolling of the hull.

18. The system as claimed in claim 1 wherein the vessel comprises a wind capture system capable of controllably presenting a variable wind heeling load to amplify the rolling motion of the hull; and the wind capture system comprises a system of shutters in which wind heeling load on the hull is varied by opening and closing the shutters.

19. The system of claim 18 wherein the system of shutters may be rotated into a favorable orientation with respect to the wind direction and/or rotated in phase with the rolling motion of the vessel.

20. (canceled)

21. A method for elevating a body of water, the method comprising:
adapting a vessel, sitting water, having a hull to roll freely in response to wave energy; and
positioning at least one or more inclined channels mounted within and/or on the hull to convert the rolling motion of the hull to vertical displacement of water; and
arranging a plurality of reservoirs in said vessel, wherein a separate reservoir for receiving water is position at one or more ends of the plurality of inclined channels, such that water can only travel from a reservoir up the next inclined channel to a next reservoir in response to the rolling action of the hull to provide vertical displacement of water.

22. The system as claimed in claim 1 wherein said vertical displacement of water is adapted to be allowed to flow under gravity through an energy conversion system to capture energy.
